(19) United States
(12) Patent Application Publication
(10) Pub. No.: US 2011/0026124 A1
(43) Pub. Date: Feb. 3, 2011

(54) MULTI-FUNCTIONAL OPTIC FILM

(75) Inventors: Kyoung Hwa Kim, Seongnam-si (KR); Dae Shik Kim, Yongin-si (KR); Hyo Jin Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: KOLON INDUSTRIES, INC., Gwacheon-si, Gyeonggi-do (KR)

(21) Appl. No.: 12/745,383

(22) PCT Filed: Nov. 28, 2008
(86) PCT No.: PCT/KR2008/007063

§ 371 Date: Oct. 25, 2010

(30) Foreign Application Priority Data
Nov. 30, 2007 (KR) 10-2007-0123898
Nov. 28, 2008 (KR) 10-2008-0119663

(51) Int. Cl. G02B 5/02

(52) U.S. Cl. 359/599

(57) ABSTRACT

Disclosed is a multifunctional optical sheet for use in liquid crystal displays, which can exhibit appropriate hiding performance while realizing luminance equivalent to that of a conventional case in which a prism sheet is layered on a light diffusion member, thus reducing the number of sheets to be mounted in a backlight unit.

### TECHNICAL FIELD

The present invention relates to a multifunctional optical sheet for use in liquid crystal displays.

### BACKGROUND ART

As industrial society has been being partially transformed into an advanced information age, the importance of electronic displays as a medium for displaying and transferring various pieces of information is increasing day by day. Conventionally, a bulky CRT (Cathode Ray Tube) was widely used therefor but faces considerable use limitations as a result of the space required to mount it, thus making it difficult to manufacture CRTs of larger sizes, and accordingly CRTs are being replaced with various types of flat panel displays, including liquid crystal displays (LCDs), plasma display panels (PDPs), field emission displays (FEDs), and organic electroluminescent displays. Among such flat panel displays, LCDs in particular, are technologically intensive products resulting from a combination of liquid crystal-semiconductor techniques and are advantageous because they are thin and lightweight and consume little power. Therefore, research and development into structures and manufacturing techniques thereof is continuing. Nowadays, LCDs, which have already been applied to fields such as notebook computers, monitors for desktop computers and portable personal communication devices (PDAs and mobile phones), are being manufactured in larger sizes, and thus it is possible to apply LCDs to large-sized TVs such as HD (High-Definition) TVs. As a result, LCDs are receiving attention as novel displays able to substitute for CRTs, which used to be synonymous for displays.

In LCDs, because the liquid crystals themselves cannot emit light, an additional light source is provided at the back surface thereof so that the intensity of light passing through the liquid crystals in each pixel is controlled to realize contrast. More specifically, the LCD, serving as a device for adjusting light transmittance using the electrical properties of a liquid crystal material, emits light from a light source lamp mounted to the back surface thereof, and the light thus emitted is passed through various functional prism films or sheets to thus cause light to be uniform and directional, after which such controlled light is also passed through a color filter, thereby realizing red, green, and blue (R, G, B) colors. Furthermore, the LCD is of an indirect light emission type, which realizes an image by controlling the contrast of each pixel through an electrical method. As such, a light-emitting device provided with a light source is regarded as important in determining the quality of the image of the LCD, including luminance and uniformity.

Such a light-emitting device is mainly exemplified by a backlight unit. Typically, a backlight unit causes light to be emitted using a light source such as a cold cathode fluorescent lamp (CCFL), so that such emitted light is sequentially passed through a light guide plate, a light diffusion member such as a light diffusion sheet or a light diffusion plate, and a prism sheet, thus reaching a liquid crystal panel. The light guide plate functions to transfer light emitted from the light source in order to distribute it over the entire front surface of the liquid crystal panel, which is planar, and the light diffusion member plays a role in realizing uniform light intensity over the entire front surface of a screen. The prism sheet functions to control the light path so that light traveling in various directions through the light diffusion member is transformed within a range of viewing angles θ suitable for enabling the image to be viewed by an observer. Further, a reflection sheet is provided under the light guide plate to reflect light, which does not reach the liquid crystal panel and is outside of the light path, so that such light is used again, thereby increasing the efficient use of the light source.

In order to effectively transfer such emitted light to the liquid crystal panel as mentioned above, a plurality of films having various functions is provided. As a result of the use of the plurality of sheets, however, light interference occurs, and further, the films may become damaged owing to physical contact between the sheets, undesirably causing problems such as low productivity and high cost.

Recently, attempts to reduce the number of optical sheets in order to simplify the production process have been made. There are exemplified cases in which a prism film is attached to an upper surface of a light diffusion member or a prism pattern is formed on a light diffusion member. Such a plate is advantageous in terms of the manufacturing cost or the productivity, but is problematic in that an increase in luminance thereof falls very short of expectations.

Therefore, the present inventors have verified that luminance may be sufficiently increased while minimizing the use of optical sheets for increasing luminance, hiding performance may be additionally improved, and the good quality of emitted light may be maintained, thus completing the present invention.

### DISCLOSURE

### Technical Problem

Accordingly, the present inventors have devised a multifunctional optical sheet which is composed of a reduced number of sheets but is able to exhibit the same functions as those of a conventional case in which a light diffusion member and a prism sheet are mounted, thereby solving the problems due to the use of the plurality of sheets and remarkably reducing the manufacturing process and the costs thereof.

Therefore, the present invention provides a multifunctional optical sheet, which is capable of exhibiting luminance equivalent to that of a conventional case in which a prism sheet is layered on a light diffusion member.

In addition, the present invention provides a multifunctional optical sheet, which is capable of imparting appropriate hiding performance.

In addition, the present invention provides a multifunctional optical sheet, in which the number of sheets to be mounted in a backlight unit is reduced, thus making a display thinner.

### Technical Solution

A preferred embodiment of the present invention provides a multifunctional optical sheet, including a substrate layer; a light diffusion layer formed on one surface or both surfaces of the substrate layer and including a binder resin and light-diffusing particles; an air layer formed on the light diffusion layer and including a binder resin and foamed beads; and a light-collecting layer formed on the air layer.

Another preferred embodiment of the present invention provides a multifunctional optical sheet, including a substrate layer; a light diffusion layer formed on one surface or both surfaces of the substrate layer and including a binder resin and light-diffusing particles; and a light-collecting layer formed on the light diffusion layer and including a photosensitive resin composition and foamed beads.

A further preferred embodiment of the present invention provides a multifunctional optical sheet, including a substrate layer; and a light-collecting layer formed on one surface or both surfaces of the substrate layer and including a photosensitive resin composition, light-diffusing particles and foamed beads.

In the multifunctional optical sheet, the foamed beads may be formed by mixing a resin for a layer including the foamed beads with a foaming agent thus preparing a mixture, applying the mixture on a predetermined coating surface, and then heating the applied mixture to thus be foamed.

In the multifunctional optical sheet, the foamed beads may be contained in the air layer in an amount of 30˜300 parts by weight based on 100 parts by weight of the binder resin.

In the multifunctional optical sheet, the air layer may have a thickness of 2˜100 μm.

In the multifunctional optical sheet, the binder resin for the air layer may be acrylic polyol.

In the multifunctional optical sheet, the foamed beads may be contained in the light-collecting layer in an amount of 1˜30 parts by weight based on 100 parts by weight of the photosensitive resin composition.

In the multifunctional optical sheet, the foamed beads may have a diameter of 2˜100 μm.

In the multifunctional optical sheet, the light-collecting layer may have a linear or non-linear array pattern of any prism structure selected from among a polypyramidal structure, a conical structure, a hemispherical structure, and a non-spherical structure.

In the multifunctional optical sheet, the light-diffusing particles may have a diameter of 1˜80 μm.

In the multifunctional optical sheet, in the case where the light-diffusing particles are contained in the light diffusion layer, the light-diffusing particles may be used in an amount of 50˜300 parts by weight based on 100 parts by weight of the binder resin. In the case where the light-diffusing particles are contained in the light-collecting layer, the light-diffusing particles may be used contained in an amount of 1˜15 parts by weight based on 100 parts by weight of the photosensitive resin composition.

### ADVANTAGEOUS EFFECTS

According to the present invention, the multifunctional optical sheet can improve luminance while uniformly diffusing light emitted from a light source, can realize superior hiding performance, can remarkably simplify the manufacturing process compared to a conventional case in which a light diffusion member and a prism sheet are separately mounted, can reduce the manufacturing cost, and enables the manufacture of a thinner LCD.

Also, according to the present invention, the multifunctional optical sheet can prevent the loss of light due to light interference, scattering or absorption occurring as a result of the use of a plurality of sheets, and can also prevent damage to the sheets.

Also, according to the present invention, the multifunctional optical sheet can reduce the number of sheets to be mounted in a backlight unit, thus realizing a thinner display.

### DESCRIPTION OF DRAWINGS

FIG. 1 is a cross-sectional view showing a multifunctional optical sheet according to a preferred embodiment of the present invention; and

FIGS. 2 and 3 are cross-sectional views showing a multifunctional optical sheet according to other preferred embodiments of the present invention.

### DESCRIPTION OF THE REFERENCE NUMERALS IN THE DRAWING

10: substrate layer
20: light diffusion layer
25: light-diffusing particles
30: air layer
35: foamed bead
40: light-collecting layer

### BEST MODE

Hereinafter, a detailed description will be given of the present invention with reference to the appended drawings.

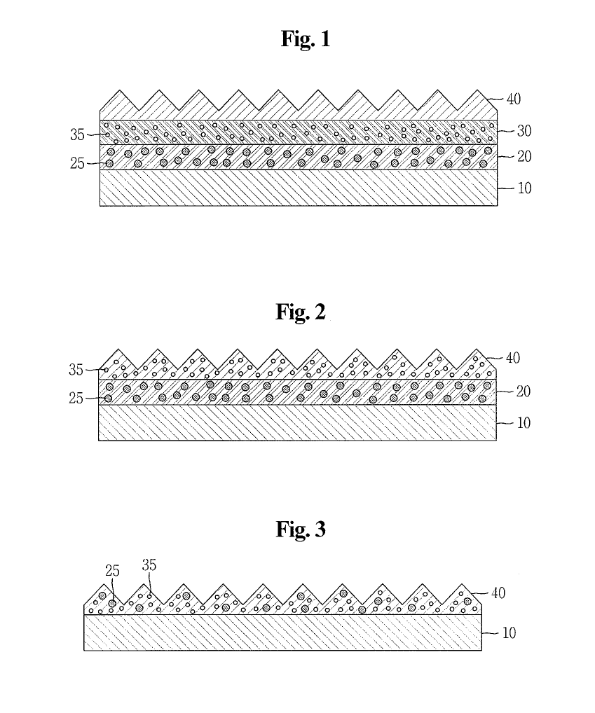

FIG. 1 is a cross-sectional view showing a multifunctional optical sheet according to a preferred embodiment of the present invention, and FIGS. 2 and 3 are cross-sectional views showing a multifunctional optical sheet according to other preferred embodiments of the present invention. Throughout the drawings, the same reference numerals refer to the same elements for convenience, but this does not mean that they are the same as each other in terms of the composition and the form.

According to the present invention, the multifunctional optical sheet may have a structure composed of a substrate layer 10 and a light-collecting layer 40 formed on one surface or both surfaces thereof. Also, a light diffusion layer 20 may be further disposed between the substrate layer 10 and the light-collecting layer 40. The multifunctional optical sheet includes foamed beads 35 and light-diffusing particles 25, and the present invention may be embodied as follows depending on the structure of a layer including foamed beads or light-diffusing particles.

Specifically, according to a preferred embodiment of the present invention, as shown in FIG. 1, a multifunctional optical sheet may be composed of a substrate layer 10, a light diffusion layer 20 including light-diffusing particles 25 formed on one surface or both surfaces of the substrate layer 10, an air layer 30 including foamed beads 35 formed on the light diffusion layer 20, and a light-collecting layer 40 formed on the air layer 30.

According to another preferred embodiment of the present invention, as shown in FIG. 2, a multifunctional optical sheet may be composed of a substrate layer 10, a light diffusion layer 20 including light-diffusing particles 25 formed on one surface or both surfaces of the substrate layer 10, and a light-collecting layer 40 including foamed beads 35 formed on the light diffusion layer 20.

According to a further preferred embodiment of the present invention, as shown in FIG. 3, a multifunctional optical sheet may be composed of a substrate layer 10, and a light-collecting layer 40 including light-diffusing particles 25 and foamed beads 35 formed on one surface or both surfaces of the substrate layer 10.

The multifunctional optical sheet according to the present invention includes the air layer 30 or the light-collecting layer 40, having the foamed beads 35, at an appropriate position on the substrate layer 10, in order to prevent the reduction of luminance as a result of the absence of an air layer due to attachment of a light diffusion member and a prism sheet.

Thus, on the substrate layer, the light-diffusing particles 25 are used to impart a light diffusion function, and also, the foamed beads 35 are used to form an air layer, thus preventing the reduction of luminance.

The foamed beads 35 are formed by mixing a binder resin for a layer including foamed beads with a foaming agent thus preparing a mixture, applying the mixture, and heating the applied mixture to thus be foamed. Specifically, the resin for the layer including the foamed beads 35, namely, for the air layer 30 or the light-collecting layer 40, is mixed with the foaming agent, after which the mixture is applied on a coating surface, namely, the upper surface of the light diffusion layer 20 or the substrate layer 10, and then heated so that the foaming agent is foamed while evaporating. The foaming agent is in the form of beads having a core-shell double structure. The core of the foaming agent is foamed upon evaporation, resulting in the foamed beads 35 containing air. To form the air layer adequate for causing refractive effects upon foaming, the foamed beads 35 may have a diameter of 2˜100 μm, which is 1.2˜2 times the diameter of the foaming agent before being foamed. In the case where the layer including the foamed beads is the air layer 30, the foamed beads 35 are contained in an amount of 30˜300 parts by weight based on 100 parts by weight of the binder resin. In the case where the layer including the foamed beads is the light-collecting layer 40, the foamed beads 35 are contained in an amount of 1˜30 parts by weight based on 100 parts by weight of a photosensitive resin composition.

The foaming agent is not particularly limited, but examples thereof include isobutane or isopentane. To adequately foam the foaming agent, 60˜200° C. heat may be applied for 3˜300 sec. Additionally, the foaming agent may be foamed even by being heated with a UV curing lamp upon light curing.

In the case where the air layer 30 including the foamed beads 35 is formed, the binder resin for the air layer 30 may include acrylic polyol, or any resin selected from among binder resins for the light diffusion layer which will be described below.

The mixture of the binder resin and the foaming agent is foamed, thereby forming the foamed beads 35. The thickness of the air layer 30 may be set to 2˜100 μm.

Examples of the substrate layer include a polyethyleneterephthalate film, a polycarbonate film, a polypropylene film, a polyethylene film, a polystyrene film, and a polyepoxy film. Particularly useful is a polyethyleneterephthalate film or a polycarbonate film. The thickness of the substrate layer 10 may be set to 10˜1000 μm, and preferably 15˜400 μm, in order to realize superior mechanical strength, thermal stability, and flexibility and prevent the loss of transmitted light.

Further, in the case where the light diffusion layer 20 is formed, the light diffusion layer 20 is obtained by dispersing light-diffusing particles in a binder resin. The binder resin for the light diffusion layer includes a resin that adheres well to the substrate layer 10 and has good compatibility with light-diffusing particles 25 dispersed therein, for example, a resin in which light-diffusing particles 25 are uniformly dispersed so that they are not separated or precipitated. Examples of the binder resin include acrylic resin, including homopolymers, copolymers, or terpolymers of unsaturated polyester, methyl methacrylate, ethyl methacrylate, isobutyl methacrylate, n-butyl methacrylate, n-butylmethyl methacrylate, acrylic acid, methacrylic acid, hydroxyethyl methacrylate, hydroxypropyl methacrylate, hydroxyethyl acrylate, acrylamide, methylolacrylamide, glycidyl methacrylate, ethyl acrylate, isobutyl acrylate, n-butyl acrylate, and 2-ethylhexyl acrylate, urethane resin, epoxy resin, and melamine resin.

The light-diffusing particles 25 include various organic or inorganic particles. Examples of the organic particles include acrylic particles including homopolymers or copolymers of methyl methacrylate, acrylic acid, methacrylic acid, hydroxyethyl methacrylate, hydroxypropyl methacrylate, acrylamide, methylolacrylamide, glycidyl methacrylate, ethyl acrylate, isobutyl acrylate, n-butyl acrylate and 2-ethylhexyl acrylate, olefin particles including polyethylene, polystyrene and polypropylene, acryl-olefin copolymer particles, and multilayer multicomponent particles prepared by forming a layer of homopolymer particles and then forming a layer of another type of monomer thereon. Examples of the inorganic particles include silicon oxide, aluminum oxide, titanium oxide, zirconium oxide, and magnesium fluoride. Such organic and inorganic particles are merely illustrative, are not limited to the examples listed above, and may be replaced with other known materials as long as the main purpose of the present invention is achieved, as will be apparent to those skilled in that art. The case in which the type of material is changed also falls within the technical scope of the present invention.

The light-diffusing particles 25 may be dispersed in a single layer or multiple layers, and may have a diameter of 1˜80 μm. The light-diffusing particles are contained in an amount of 50˜300 parts by weight based on 100 parts by weight of the binder resin. In the case where the light-diffusing particles having the aforementioned diameter are contained in the aforementioned amount, white turbidity and separation of the particles can be prevented and appropriate light diffusion effects can be realized.

The thickness of the light diffusion layer 20 may be set to 5˜100 μm.

Also, the light-collecting layer 40 of the multifunctional optical sheet according to the present invention may be formed using a polymer resin including a UV curable resin or a heat curable resin. Particularly useful is a resin composition that is very transparent and is capable of forming a crosslink bond adequate for maintaining the shape of an optical structure. Examples thereof include epoxy resin-Lewis acid or polyethylol, unsaturated polyester-styrene, and acrylic or methacrylic acid ester. Particularly useful as a very transparent resin is acrylic or methacrylic acid ester resin, and examples thereof include oligomers, including polyurethane acrylate or methacrylate, epoxy acrylate or methacrylate, and polyester acrylate or methacrylate, which may be used alone or in combination with an acrylate or methacrylate monomer having a polyfunctional or monofunctional group.

In the present invention, the light-collecting layer 40 may include the foamed beads 35 as above or the light-diffusing particles 25. The light-diffusing particles 25 are as mentioned above, and the amount thereof may be set to 1˜15 parts by weight based on 100 parts by weight of the photosensitive resin composition.

In the present invention, the light-collecting layer 40 may have a linear or non-linear array pattern of any prism structure selected from among a polypyramidal structure, a conical structure, a hemispherical structure, and a non-spherical structure.

The thickness of the light-collecting layer 40 may be set to 5˜100 μm.

In the multifunctional optical sheet according to the present invention, the light-diffusing particles 25 function to uniformly diffuse light passed through the substrate layer 10, and the foamed beads 35 functioning as the air layer play a role in preventing the reduction of luminance and aiding the diffusion of light. The light thus diffused and refracted is directly passed through the light-collecting layer 40, and thus the loss of light is drastically reduced compared to conventional cases. Hence, in the present invention, sheets which are conventionally separately provided to impart the diffusion of light and the increase in luminance can be manufactured at once. The construction of a sheet including such a multifunctional sheet can realize luminance equivalent to that of a conventional case in which a light diffusion member and a prism sheet are separately used, and also, can diffuse light, thus improving hiding performance and reducing the manufacturing process and the manufacturing cost. In an optical sheet assembly for a backlight unit, the number of mounted sheets may be desirably reduced.

In addition, the present invention provides a backlight unit assembly formed by disposing an optical film on any one surface of the multifunctional optical sheet, thereby further increasing luminance compared to when only the multifunctional optical sheet is mounted.

A better understanding of the present invention may be obtained through the following examples, which are set forth to illustrate but are not to be construed as limiting the present invention.

### Example 1

100 parts by weight of acrylic resin 52-666 (available from Aekyung Chemical) was diluted with 30 parts by weight of methylethylketone and 80 parts by weight of toluene, thus preparing a binder resin having a refractive index of 1.49. Thereafter, spherical polymethylmethacrylate particles MH20F (available from Kolon) having an average diameter of 20 μm and a refractive index of 1.49 were added to the binder resin in an amount of 150 parts by weight based on the amount of the binder resin and then monodispersed in a single layer using a milling machine, after which the dispersion thus obtained was applied on one surface of a super-transparent polyethyleneterephthalate (PET) film FHSS (available from Kolon) 188 μm thick as a substrate layer using a gravure coater and then cured at 120° C. for 60 sec, thus forming a light diffusion layer (refractive index: 1.49) having a dry thickness of 25 μm.

Further, on one surface of the cured light diffusion layer, an air layer was formed through the following procedures. Specifically, 100 parts by weight of acrylic resin 52-666 (available from Aekyung Chemical) was diluted with 50 parts by weight of methylethylketone and 90 parts by weight of toluene, thus preparing a binder resin having a refractive index of 1.49. Thereafter, isobutane particles were added to the binder resin in an amount of 50 parts by weight based on 100 parts by weight of the binder resin and then monodispersed in a single layer using a milling machine, after which the dispersion thus obtained was applied using a gravure coater to form a dry thickness of 20 μm. After gravure coating, heat treatment at 120° C. for 60 sec was performed, thus obtaining the air layer including the isobutane particles having an average diameter of 15 μm.

Furthermore, on one surface of the air layer, a photosensitive resin composition composed of 60 parts by weight of urethane acrylate, 20 parts by weight of 2-phenylethyl methacrylate, 10 parts by weight of benzylmethacrylate, 5 parts by weight of isobutyl methacrylate, 3 parts by weight of 1,6-hexanediol acrylate and 2 parts by weight of a BAPO-based photoinitiator was applied, and the upper surface of the frame of a prism-shaped roller was coated with the photosensitive resin composition applied on the air layer, after which UV light (300 watts/inch², available from Fusion) was radiated onto the outer surface of the substrate layer, thus forming a light-collecting layer having a linear array of triangular prisms and a refractive index of 1.56.

### Example 2

100 parts by weight of acrylic resin 52-666 (available from Aekyung Chemical) was diluted with 30 parts by weight of methylethylketone and 80 parts by weight of toluene, thus preparing a binder resin having a refractive index of 1.49. Thereafter, spherical polymethylmethacrylate particles MH20F (available from Kolon) having an average diameter of 20 μm and a refractive index of 1.49 were added to the binder resin in an amount of 150 parts by weight based on the amount of the binder resin, and then monodispersed in a single layer using a milling machine, after which the dispersion thus obtained was applied on one surface of a super-transparent PET film FHSS (available from Kolon) 188 μm thick as a substrate layer using a gravure coater, and then cured at 120° C. for 60 sec, thus forming a light diffusion layer (refractive index: 1.49) having a dry thickness of 25 μm.

Further, on one surface of the cured light diffusion layer, a mixture of a photosensitive resin composition and isobutane particles in an amount of 5 parts by weight based on 100 parts by weight of the photosensitive resin composition was applied, the photosensitive resin composition being composed of 60 parts by weight of urethane acrylate, 20 parts by weight of 2-phenylethyl methacrylate, 10 parts by weight of benzylmethacrylate, 5 parts by weight of isobutyl methacrylate, 3 parts by weight of 1,6-hexanediol acrylate and 2 parts by weight of a BAPO-based photoinitiator. Then, the upper surface of the frame of a prism-shaped roller was coated with the photosensitive resin composition applied on the light diffusion layer, after which UV light (300 watts/inch², available from Fusion) was radiated onto the outer surface of the substrate layer, thus forming a light-collecting layer having a linear array of triangular prisms and including isobutane particles having an average diameter of 15 μm foamed using additional curing heat (150° C., 5 sec) occurring from a UV curing machine, with a refractive index of 1.56.

### Example 3

On one surface of a super-transparent PET film FHSS (available from Kolon) 188 μm thick as a substrate layer, a mixture of a photosensitive resin composition, polymethylmethacrylate particles (MH20F, available from Kolon) in an amount of 5 parts by weight based on 100 parts by weight of the photosensitive resin composition and isobutane particles in an amount of 5 parts by weight based on 100 parts by weight of the photosensitive resin composition was applied, the photosensitive resin composition being composed of 60 parts by weight of urethane acrylate, 20 parts by weight of 2-phenylethyl methacrylate, 10 parts by weight of benzylmethacrylate, 5 parts by weight of isobutyl methacrylate, 3 parts by weight of 1,6-hexanediol acrylate and 2 parts by weight of a BAPO-based photoinitiator. Then, the upper surface of the frame of a prism-shaped roller was coated with the photosensitive resin composition applied on the substrate layer, after which UV light (300 watts/inch², available from Fusion) was radiated onto the outer surface of the substrate layer, thus forming a light-collecting layer having a linear array of triangular prisms and including isobutane particles having an average diameter of 15 μm foamed using curing heat (150° C., 5 sec) occurring from a UV curing machine, with a refractive index of 1.56.

### Example 4

A multifunctional optical sheet was manufactured in the same manner as in Example 1, with the exception that the isobutane particles were contained in the air layer in an amount of 70 parts by weight based on 100 parts by weight of the binder resin.

### Example 5

A multifunctional optical sheet was manufactured in the same manner as in Example 1, with the exception that the isobutane particles were contained in the air layer in an amount of 100 parts by weight based on 100 parts by weight of the binder resin.

### Example 6

A multifunctional optical sheet was manufactured in the same manner as in Example 2, with the exception that the isobutane particles were used in an amount of 10 parts by weight based on 100 parts by weight of the photosensitive resin composition.

### Example 7

A multifunctional optical sheet was manufactured in the same manner as in Example 2, with the exception that the isobutane particles were used in an amount of 15 parts by weight based on 100 parts by weight of the photosensitive resin composition.

### Example 8

A multifunctional optical sheet was manufactured in the same manner as in Example 3, with the exception that the isobutane particles were used in an amount of 7 parts by weight based on 100 parts by weight of the photosensitive resin composition.

### Example 9

A multifunctional optical sheet was manufactured in the same manner as in Example 3, with the exception that the isobutane particles were used in an amount of 9 parts by weight based on 100 parts by weight of the photosensitive resin composition.

### Example 10

A multifunctional optical sheet was manufactured in the same manner as in Example 3, with the exception that the polymethylmethacrylate particles (MH20F, available from Kolon) were used in an amount of 3 parts by weight based on 100 parts by weight of the photosensitive resin composition.

### Example 11

A multifunctional optical sheet was manufactured in the same manner as in Example 3, with the exception that the polymethylmethacrylate particles (MH20F, available from Kolon) were used in an amount of 7 parts by weight based on 100 parts by weight of the photosensitive resin composition.

### Comparative Example 1

A multifunctional optical sheet was manufactured in the same manner as in Example 1, with the exception that the air layer was not formed.

### Comparative Example 2

A multifunctional optical sheet was manufactured in the same manner as in Example 3, with the exception that the isobutane particles were not used.

### Comparative Example 3

A prism film (LC213, available from Kolon) was layered on one surface of a light diffusion film (LD602, available from Kolon).

The properties of the multifunctional optical sheets of the above examples and comparative examples were evaluated as follows. The evaluation results are shown in Table 1 below.

<Luminance>

A backlight unit for a 32″ LCD panel was preheated for 2 hours or more, a diffusion plate was mounted thereon, and then the multifunctional optical sheet of each of the examples and Comparative Examples 1 and 2 or the light diffusion film and the prism film of Comparative Example 3 was layered thereon, after which luminance thereof was measured. The luminance was measured in a manner such that a sheet for measuring luminance was mounted on the diffusion plate, the luminance thereof was measured, the sheet for measuring luminance was removed, and then the backlight unit was waited for stabilization in a state of being turned-on until the difference between the luminance in a state in which only the diffusion plate was provided before another sheet for measuring luminance was mounted and the luminance in a state in which only the diffusion plate was provided before the sheet of each of the examples and comparative examples was layered was less than 0.05%. As such, the measurement of luminance using a luminance meter (model number: BM-7, available from Topcon, Japan) was repeated 3 times at 9 points according to VESA standard, and the luminance values at the center point were averaged and then evaluated according to the following:

◯: luminance of 9000 cd/m² or more

Δ: luminance between 6500 cd/m² and less than 9000 cd/m²

X: luminance less than 6500 cd/m²

<Hiding Performance>

A backlight unit was turned-on and preheated for 2 hours, and then the luminance thereof was measured using a BM-7 available from Topcon. All of the sheets other than the reflection sheet and the diffusion plate were removed from the backlight unit (32″), and the optical member of the examples and comparative examples was mounted, after which luminance values were measured at an interval of 1 mm in every direction from the brightest point, and the difference between the maximum luminance and the minimum luminance was divided by the maximum luminance and then the resulting value was converted into a percentage, called a Waver fraction (%). This value indicates the lamp hiding performance of the optical member of the examples and comparative examples. As the Waber fraction was higher, hiding performance was evaluated to be low.

TABLE 1

| | Layer including Light-Diffusing Particles | | | | |
|---|---|---|---|---|---|
| | (LDP) and Foamed Beads (FB) and Amount | | | | Hiding |
| | Light Diffusion | | Light-Collecting | | Performance |
| | Layer | Air Layer | Layer | Luminance | (%) |
| Ex. 1 | LDP, 150 wt parts | FB, 50 wt part | No Beads | ∘ | 0.75 |
| Ex. 2 | LDP, 150 wt parts | Absence | FB, 5 wt parts | ∘ | 0.80 |
| Ex. 3 | Absence | Absence | LDP 5 wt parts + | ∘ | 0.87 |
| | | | FB 5 wt parts | | |
| Ex. 4 | LDP, 150 wt parts | FB, 70 wt part | No Beads | ∘ | 0.74 |
| Ex. 5 | LDP, 150 wt parts | FB, 100 wt part | No Beads | ∘ | 0.72 |
| Ex. 6 | LDP, 150 wt parts | Absence | FB, 10 wt parts | Δ | 0.70 |
| Ex. 7 | LDP, 150 wt parts | Absence | FB, 15 wt parts | Δ | 0.68 |
| Ex. 8 | Absence | Absence | LDP 5 wt parts + | ∘ | 0.73 |
| | | | FB 7 wt parts | | |
| Ex. 9 | Absence | Absence | LDP 5 wt parts + | ∘ | 0.72 |
| | | | FB 9 wt parts | | |
| Ex. 10 | Absence | Absence | LDP 3 wt parts + | ∘ | 0.87 |
| | | | FB 5 wt parts | | |
| Ex. 11 | Absence | Absence | LDP 7 wt parts + | Δ | 0.70 |
| | | | FB 5 wt parts | | |
| C. Ex. 1 | LDP, 150 wt parts | Absence | No Beads | x | 1.06 |
| C. Ex. 2 | Absence | Absence | LDP 5 wt parts | x | 1.08 |

| | | | |
|---|---|---|---|
| C. Ex. 3 | Light Diffusion Film + Prism Film | ∘ | 0.80 |

As is apparent from the results of evaluation of the above properties, the multifunctional optical sheets including the foamed beads in the examples according to the present invention could be seen to have luminance or hiding luminance superior to those of the comparative examples without foamed beads, and to exhibit luminance and hiding performance equivalent to those of the conventional case in which the prism film and the light diffusion film were used together.

Accordingly, the multifunctional optical sheet according to the present invention can minimize the loss of light and can increase the use efficiency of the light source, thus improving luminance and hiding performance. Even when the light diffusion film and the prism film as in the conventional case are not separately used, the multifunctional optical sheet according to the present invention can exhibit luminance equivalent to or higher than that of the conventional case, thus preventing problems due to the use of a plurality of films.

1. A multifunctional optical sheet, comprising:
a substrate layer;
a light diffusion layer formed on one surface or both surfaces of the substrate layer and including a binder resin and light-diffusing particles;
an air layer formed on the light diffusion layer and including a binder resin and foamed beads; and
a light-collecting layer formed on the air layer.

2. A multifunctional optical sheet, comprising:
a substrate layer;
a light diffusion layer formed on one surface or both surfaces of the substrate layer and including a binder resin and light-diffusing particles; and
a light-collecting layer formed on the light diffusion layer and including a photosensitive resin composition and foamed beads.

3. A multifunctional optical sheet, comprising:
a substrate layer; and
a light-collecting layer formed on one surface or both surfaces of the substrate layer and including a photosensitive resin composition, light-diffusing particles and foamed beads.

4. The multifunctional optical sheet according to any one of claims 1 to 3, wherein the foamed beads are formed by mixing a resin for a layer including the foamed beads with a foaming agent thus preparing a mixture, applying the mixture on a predetermined coating surface, and then heating the applied mixture to thus be foamed.

5. The multifunctional optical sheet according to claim 1, wherein the foamed beads are contained in the air layer in an amount of 30˜300 parts by weight based on 100 parts by weight of the binder resin.

6. The multifunctional optical sheet according to claim 1 or 5, wherein the air layer has a thickness of 2˜100 μm.

7. The multifunctional optical sheet according to claim 1 or 5, wherein the binder resin for the air layer is acrylic polyol.

8. The multifunctional optical sheet according to claim 2 or 3, wherein the foamed beads are contained in the light-collecting layer in an amount of 1˜30 parts by weight based on 100 parts by weight of the photosensitive resin composition.

9. The multifunctional optical sheet according to any one of claims 1 to 3, wherein the foamed beads have a diameter of 2˜100 μm.

10. The multifunctional optical sheet according to any one of claims 1 to 3, wherein the light-collecting layer has a linear or non-linear array pattern of any prism structure selected from among a polypyramidal structure, a conical structure, a hemispherical structure, and a non-spherical structure.

11. The multifunctional optical sheet according to any one of claims 1 to 3, wherein the light-diffusing particles have a diameter of 1˜80 μm.

12. The multifunctional optical sheet according to claim 1 or 2, wherein the light-diffusing particles are contained in an amount of 50˜300 parts by weight based on 100 parts by weight of the binder resin.

13. The multifunctional optical sheet according to claim 3, wherein the light-diffusing particles are contained in an amount of 1˜15 parts by weight based on 100 parts by weight of the photosensitive resin composition.
